(19) United States
(12) Patent Application Publication
(10) Pub. No.: US 2011/0047482 A1
(43) Pub. Date: Feb. 24, 2011

(54) AUDIENCE RESPONSE WEB SERVER

(75) Inventors: Donald Ray Arthurs, Leetonia, OH (US); Todd Horrell, Warren, OH (US)

Correspondence Address: BENESCH, FRIEDLANDER, COPLAN & ARONOFF LLP;ATTN: IP DEPARTMENT DOCKET CLERK, 200 PUBLIC SQUARE, SUITE 2300, CLEVELAND, OH, 44114-2378, US

(73) Assignee: TURNING TECHNOLOGIES, LLC, Youngstown, OH (US)

(21) Appl. No.: 12/543,280

(22) Filed: Aug. 18, 2009

(51) Int. Cl. G06F 15/16; G06F 3/048

(52) U.S. Cl. 715/751

(57) ABSTRACT

An audience response web server may communicate polling data incorporating a polling question during an interactive polling session running on the audience response web server. During the interactive polling session running on the audience response web server, the audience response web server may also receive response data representing responses to the polling question. The audience response web server may also aggregate the responses to the polling question and communicate results data incorporating the aggregated responses to the polling question during the interactive polling session.

### FIELD OF THE INVENTION

The present application relates to an audience response system. More particularly, the present application relates to an audience response web server and method for implementing the audience response system.

### BACKGROUND

Prior audience response systems have been employed to retrieve (or receive) responses from a group of individuals at a central location. Such systems may be used in classroom settings, corporate meetings, or in other gatherings of individuals. These systems may include a base unit and a plurality of response devices.

Other audience response systems have been employed to retrieve (or receive) responses at non central locations where the individuals may be located at different physical locations from each other and from a base unit or host computer running the audience response software. These non-colocated response devices employed a direct physical connection to the base unit or host computer running the audience response software, or a persistent connection was established using a routing application or virtual response device.

### BRIEF DESCRIPTION OF THE DRAWINGS

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

FIG. 1 illustrates an audience response system incorporating an example audience response web server.

FIG. 2 illustrates a block diagram of an example audience response system incorporating an audience response web server.

FIG. 3 illustrates a flow chart showing an example method for an audience response web server and audience response devices to communicate.

FIG. 4 illustrates a flow chart showing an example method for an audience response web server and a web-enabled device to communicate.

FIG. 5 illustrates a flow chart showing an example method for an audience response web server to communicate with a network device.

FIG. 6 illustrates a flow chart showing an example method for an audience response web server to communicate with a wireless device.

FIG. 7 illustrates a flow chart showing an example method for an audience response web server to communicate with a client device.

FIG. 8 illustrates a block diagram of a computer on which an example audience response web server may be implemented.

### DETAILED DESCRIPTION

The following includes definitions of selected terms employed herein. The definitions include various examples, forms, or both of components that fall within the scope of a term and that may be used for implementation. The examples are not intended to be limiting. Both singular and plural forms of terms may be within the definitions.

“Computer communication,” as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11, IEEE 802.15), an Ethernet system (e.g., IEEE 802.3), a token ring system (e.g., IEEE 802.5), a local area network (LAN), a wide area network (WAN), a point-to-point system, a circuit switching system, a packet switching system, combinations thereof, and so on.

“Computer-readable medium,” as used herein, refers to a medium that participates in directly or indirectly providing signals, instructions and/or data. A computer-readable medium may take forms, including, but not limited to, non-volatile media, volatile media, and transmission media. Non-volatile media may include, for example, optical or magnetic disks, and so on. Volatile media may include, for example, optical or magnetic disks, dynamic memory and the like. Transmission media may include coaxial cables, copper wire, fiber optic cables, and the like. Transmission media can also take the form of electromagnetic radiation, like that generated during radio-wave and infra-red data communications, or take the form of one or more groups of signals. Common forms of a computer-readable medium include, but are not limited to, a floppy disk, a flexible disk, a hard disk, a magnetic tape, other magnetic media, a CD-ROM, other optical media, punch cards, paper tape, other physical media with patterns of holes, a RAM, a ROM, an EPROM, a FLASH-EPROM, or other memory chip or card, a memory stick, a carrier wave/pulse, and other media from which a computer, a processor or other electronic device can read. Signals used to propagate instructions or other software over a network, like the Internet, can be considered a “computer-readable medium.”

“Logic,” as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

An “operable connection,” or a connection by which entities are “operably connected,” is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection.

“Signal,” as used herein, includes but is not limited to one or more electrical or optical signals, analog or digital signals, data, one or more computer or processor instructions, messages, a bit or bit stream, or other means that can be received, transmitted and/or detected.

“Software,” as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically and/or statically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may depend, for example, on requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein may be produced using programming languages and tools like Java, Java Script, Java.NET, ASP.NET, Cocoa, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“User,” as used herein, includes but is not limited to one or more persons, software, computers or other devices, or combinations of these.

Some portions of the detailed descriptions that follow are presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like. It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

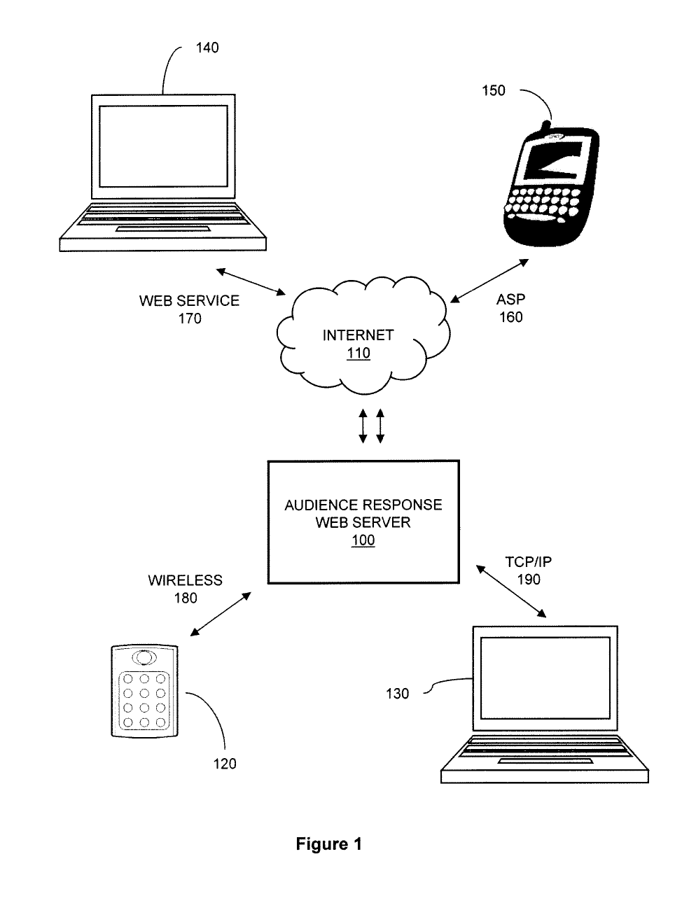

FIG. 1 illustrates an audience response system incorporating an example audience response web server 100. Server 100 may connect to the Internet 110 as well as to various other networks, such as an LAN, WAN, and other known networks. Server 100 may run an interactive polling session in which various different devices (i.e. wireless response device 120, client-side device 130, network device 140, web-enabled device 150) may participate to display polling questions, provide responses to polling questions, or both. Server 100 may control access to the interactive polling session by the participating devices. During the interactive polling session, server 100 may communicate polling data including a polling question. Server 100 may also receive response data representing the various devices' responses to the polling question. Server 100 may also aggregate the received responses to the polling question and communicate to the various devices results data incorporating the aggregated responses to the polling question. Server 100 may repeat this process of communicating polling questions, receiving responses and communicating aggregated responses until the conclusion of the polling session.

In one embodiment, server 100 may generate active server pages (“ASP”) 160 or server 100 may dynamically generate web pages using similar technologies. In another embodiment, server 100 may generate a static web page and periodically update the contents of the web page. Web-enabled device 150 may request access to a polling session running on server 100. Server 100 may require web-enabled device 150 to provide credentials such as username, password, account number, or a combination in order to obtain access to the polling session. Server 100 may grant or deny access to the polling session based on the credentials that web-enabled device 150 provides. Web-enabled device 150 may be one or a combination of various devices known in the art (e.g. PDA, smart phone, wireless telephone, cellular telephone, laptop computer, entertainment device, media player, and so on). Web-enabled device 150 may be web enabled to request, receive and/or display web page information.

Server 100 may generate web pages viewable through a web browser running in web-enabled device 150. For example, server 100 may generate a polling question web page incorporating the polling question. Web-enabled device 150 may request and server 100 may communicate the polling question web page through the Internet 110 or any other network for display via the web browser running on web-enabled device 150. Alternatively, server 100 may communicate the polling question web page without receiving a request.

A user of web-based device 150 may answer the polling question by entering an answer via an input mechanism (e.g. keyboard, buttons, click wheel, track ball, touch screen, and so on) in web-enabled device 150. Server 100 may receive the answer and aggregate all answers received from all devices participating in the polling session.

In one embodiment, server 100 may generate a results web page incorporating the aggregated answers. Server 100 may then communicate the results web page to web-enabled device 150 for display via the web browser. Server 100 may continue to aggregate incoming answers and periodically recommunicate the results web page to web-enabled device 150 to ensure that information being displayed through the web browser is up-to-date. Web-enabled device 150 may request and server 100 may communicate the results web page through the Internet 110 or any other network for display via the web browser running on web-enabled device 150. Alternatively, server 100 may communicate the results web page without receiving a request.

In one embodiment, server 100 may communicate a polling web page including a script to web-enabled device 150. The script may periodically request updates of the polling web page from server 100. Server 100 may communicate updates to the polling web page depending on the current status of the polling session. For example, if polling is open, server 100 may communicate polling question data including the polling question. If polling has concluded and results are being presented, server 100 may communicate aggregated results data including the aggregated results to the polling question.

In one embodiment, periodic updates may take place on one second or one and a half second intervals. The periodic updates may create the effect to a user of web-enabled device 150 of a live web page.

In another embodiment, server 100, via the Internet 110 or any other network, exposes interfaces to software applications running on network device 140. Network device 140 may be one or a combination of various devices known in the art (e.g. PDA, smart phone, wireless telephone, cellular telephone, laptop computer, entertainment device, media player, and so on). An application on network device 140 may discover the interfaces exposed by server 100 via the Internet 110 or any other network. For example, server 100 may expose polling interfaces reflecting polling sessions. These polling interfaces may be exposed as a web service 170 or similar technology. The application on network device 140 may use web service 170 to gain access to the polling session. As a response to a request, server 100 may return data containing the polling question. The application on network device 140 may then use the data containing the polling question including, for example, displaying the polling question for a user to see and respond to.

After the user inputs a response via an input mechanism (e.g. keyboard, buttons, click wheel, track ball, touch screen, and so on), network device 140 may communicate data containing the user's answer to server 100. Server 100 may aggregate answers received from all devices participating in the polling session and generate results incorporating the aggregated answers. As a response to the data containing the user's answer to the polling question, server 100 may return data containing the aggregated answers to the polling questions. T he application on network device 140 may then use of the aggregated answers information including, for example, displaying the aggregated answers for the user to see.

In another embodiment, server 100 may be capable of communicating with one or more wireless response devices 120. Communications between server 100 and wireless response devices 120 may be achieved via various different types of wireless 180 communication (e.g. infrared, radio frequency, and so on). Wireless response device 120 may be one or a combination of various devices known in the art (e.g. PDA, smart phone, wireless telephone, cellular telephone, laptop computer, entertainment device, media player, and so on). Wireless response device 120 may request access to the interactive polling session. Server 100 or a base unit attached to server 100 (not shown) may grant or deny access. Server 100 or a base unit attached to server 100 may cause the display of a polling questions for a user to read and respond. The user may via an input mechanism (e.g. keyboard, buttons, click wheel, track ball, touch screen, and so on) in wireless response device 120 respond to the polling question. Server 100 or a base unit attached to server 100 may receive answers from all devices including wireless response device 120 and aggregate the answers. Server 100 or a base unit attached to server 100 may then cause the aggregated answers to be displayed. In an alternative embodiment, wireless response device 120 may request and server 100 or a base unit attached to server 100 may communicate data representing the aggregated answers.

In yet another embodiment, server 110 may be capable of communicating with client devices 130 via TCP/IP 190 or a substantially equivalent network communications protocol. Client device 130 may be one or a combination of various devices known in the art (e.g. PDA, smart phone, wireless telephone, cellular telephone, laptop computer, entertainment device, media player, and so on). Client device 130 may request access to the interactive polling session. Server 100 may grant or deny access. Server 100 may cause the display of a polling questions for a user to read and respond. In an alternative embodiment, server 100 may communicate data containing the polling session to client device 130 for display. A user may via an input mechanism (e.g. keyboard, buttons, click wheel, track ball, touch screen, and so on) in client device 130 respond to the polling question. Server 100 may receive answers from all devices including client device 130 and aggregate the answers. Server 100 may then cause the aggregated answers to be displayed. In an alternative embodiment, client device 130 may request and server 100 may communicate data representing the aggregated answers for display.

Therefore, server 100 may run an interactive polling session in which various different devices may participate. These devices may be colocated or located at different locations from each other or from server 100 or a base unit operably connected to server 100. The devices may participate in the polling session to display polling questions and aggregated responses, to provide responses to polling questions, or both. Devices not colocated with server 100 or a base unit operably connected to server 100 may participate in the interactive polling session with minimal installation, security and connection reliability issues.

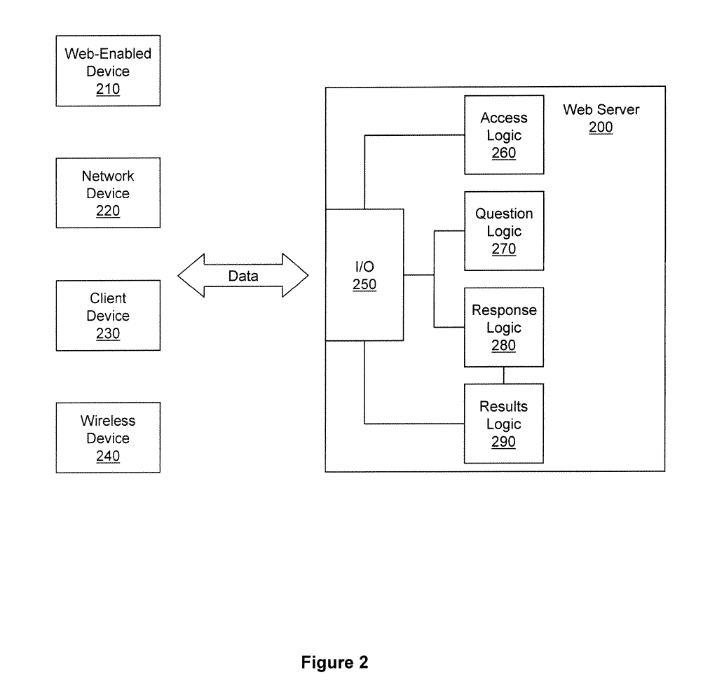

FIG. 2 illustrates a block diagram of an example system incorporating an example audience response web server 200. In one embodiment, various different devices (e.g. web-enabled device 210, network device 220, client device 230, wireless device 240) may participate in an interactive polling session. Web server 200 may include various different input/output interfaces 250 to exchange data with the devices.

In one embodiment, web server 200 includes access logic 260, question logic 270, response logic 280 and results logic 290. Access logic 260 may be configured to control access by devices or users to the interactive polling session running on web server 200. Question logic 270 may communicate during the interactive polling session polling data incorporating the polling question. Response logic 280 may receive during the interactive polling session response data representing responses to the polling question. Results logic 290 may aggregate the responses to the polling question from all devices participating in the polling session. In one embodiment, results logic 290 may aggregate the responses to the polling question by device type (i.e. wireless device, network device, web-based device, client device) or aggregate answers from only a determined type of device. In other embodiment, results logic 290 may aggregate responses by various other categories (e.g. by responding device geographical location and so on). Results logic 290 may communicate results data incorporating the aggregated responses to the polling question.

In one embodiment, web server 200 may dynamically generate web pages incorporating polling session information. Dynamically generating web pages may be accomplished through the use of a server-side language (e.g. PH P, Perl, ASP, ASP.NET, JSP, Java.NET, Cocoa, ColdFusion, and so on). In an alternative embodiment, web server 200 may generate static web pages with built-in scripts. The scripts may receive or request updates to the information displayed on the web pages.

In one embodiment, access logic 260 may control access to polling sessions by one or more web-enabled devices 210 by requiring the web-enabled device to provide credentials such as a username, account number, password, email addresses, or a combination of these. After the access logic receives the credentials, the web-enabled device 210 may join the interactive polling session.

Question logic 270 may generate a question web page incorporating the polling question. Web-enabled device 210 may periodically request the question web page incorporating the polling question from question logic 270. Question logic 270 may then transmit the question web page. Alternatively, question logic 270 may periodically transmit, without request, the question web page. Web-enabled device 210 may display the question web page via a web browser. A user of web-enabled device 210 may then respond to the polling question by entering an answer through an input mechanism (e.g. keyboard, mouse click, touch screen, and so on) in web-enabled device 210. Response logic 280 may receive response data representing responses to the polling question from devices including web-enabled device 210. Results logic 290 may generate a results web page incorporating aggregated responses to the polling question. Web-enabled device 210 may periodically request the results web page including the aggregated responses from results logic 290. Results logic 290 may then transmit the results web page. Alternatively, results logic 290 may periodically transmit without request the results web page to web-enabled device 210.

In an alternative embodiment, question logic 270 may communicate a poling web page to web-enabled device 210 together with a script. The script may periodically receive or request polling data from question logic 270 to keep the polling web page up-to-date. Question logic 270 may communicate polling data depending on the current status of the polling session. For example, if polling is open, question logic 270 may communicate polling question data for web-enabled device 210 to display the polling question via the web browser. Alternatively, question logic 270 may periodically transmit without request the polling question data. Results logic 290 may also communicate polling data depending on the current status of the polling session. For example, if polling is closed, results logic 290 may communicate results data including the aggregated responses to the polling question for web-enabled device 210 to display the aggregated responses via the web browser. Alternatively, results logic 290 may periodically transmit without request the results data to web-enabled device 210.

In one embodiment, web server 200 may expose interfaces containing polling session information to applications running on devices connected to the Internet such as example network device 220. Exposing interfaces may be accomplished through the use of software designed to support interoperable machine-to-machine interaction over a network (e.g. web services, Object Management Group's (OMG) Common Object Request Broker Architecture (CORBA), Microsoft's Distributed Component Object Model (DCOM), Sun Microsystems's Java/Remote Method Invocation (RMI), and so on). Exposed interfaces may be described in a machine-processable format such as an XML-based language (e.g. Web Services Description Language (WSDL) for web services and so on). Network device 220 may interact with web server 200 using a protocol for exchanging structured information messages (e.g. Simple Object Access Protocol (SOAP) for web services and so on).

In one embodiment, access logic 260 may be configured to control access by network device 220 to the interactive polling session on web server 200. During the interactive polling session, question logic 270 may be configured to expose a polling interface incorporating the polling question to applications running on network device 220. Question logic 270 may periodically update the exposed interface to create the effect to a user of network device 220 that the polling session has been downloaded to network device 220. In one embodiment, network device 220 includes or communicates with a display where the polling question may be displayed. A user of network device 220 may respond to the polling question by entering an answer through an input mechanism (e.g. keyboard, mouse click, and so on) in network device 220. Response logic 280 may be configured to receive response data representing responses to the polling question from applications running on devices including network device 220. Results logic 290 may be configured to expose an interface incorporating aggregated responses to the polling question to the applications running on network device 220. Results logic 290 may periodically update the exposed interface to create the effect to a user of network device 220 that the polling session has been downloaded to network device 220.

In one embodiment, web server 200 interacts with client-side audience response applications running on client device 230 via a network protocol such as TCP/IP or equivalent. Access logic 260 may be configured to control access by client device 230 to the interactive polling session running on web server 200. Question logic 270 may be configured to transmit to client device 230 polling data representing the polling question during the interactive polling session running on web server 200. The polling question may be displayed on a screen, monitor, and so on. A user of client device 230 may respond to the polling question by entering an answer through an input mechanism (e.g. keyboard, mouse click, and so on) in client device 230. Response logic 280 may be configured to receive response data representing responses to the polling question from the applications running on devices including client device 230. Results logic 290 may be configured to transmit to client device 230 aggregated responses to the polling question. Client device 230 may display or cause display of the aggregated responses.

In one embodiment, web server 200 interacts with wireless response devices such as wireless device 240. Question logic 270 may be configured to communicate the polling question. In one embodiment, question logic 270 may cause display of the polling question. The polling question may be displayed on a screen, monitor, and so on. A user of wireless device 240 may respond to the polling question by entering an answer through an input mechanism (e.g. keyboard, mouse click, and so on) in wireless device 240. Response logic 280 may be configured to receive response data representing responses to the polling question from devices including wireless device 240. Results logic 290 may be configured to aggregate responses from all devices participating in the interactive audience response session including wireless device 240. Results logic my also cause display of the aggregated responses to the polling question. The aggregated responses may be displayed on a screen, monitor, and so on.

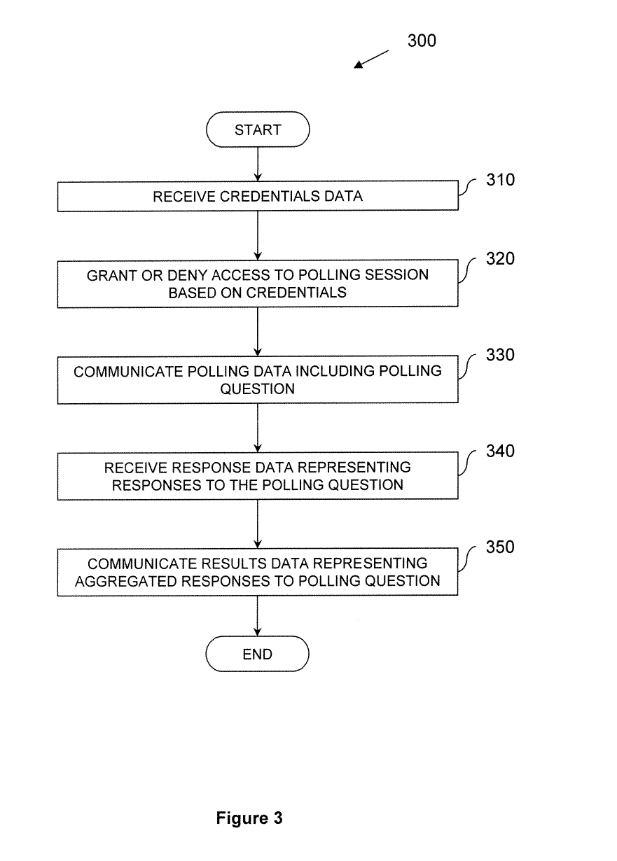

Example methods may be better appreciated with reference to the flow diagrams of FIGS. 3-7. While for purposes of simplicity of explanation, the illustrated methodologies are shown and described as a series of blocks, it is to be appreciated that the methodologies are not limited by the order of the blocks, as some blocks can occur in different orders, concurrently with other blocks from that shown and described or both. Moreover, less than all the illustrated blocks may be required to implement an example methodology. Furthermore, additional, alternative methodologies, or both can employ additional, not illustrated blocks.

In the flow diagrams, blocks denote “processing blocks” that may be implemented with logic. The processing blocks may represent a method step, an apparatus element for performing the method step or both. A flow diagram does not depict syntax for any particular programming language, methodology, or style (e.g., procedural, object-oriented, and so on). Rather, a flow diagram illustrates functional information one skilled in the art may employ to develop logic to perform the illustrated processing. It will be appreciated that in some examples, program elements like temporary variables, routine loops, and so on, are not shown. It will be further appreciated that electronic and software applications may involve dynamic and flexible processes so that the illustrated blocks can be performed in other sequences that are different from those shown, and that blocks may be combined or separated into multiple components or both. It will also be appreciated that the processes may be implemented using various programming approaches like machine language, procedural, object oriented and/or artificial intelligence techniques.

In one example, methodologies are implemented as processor executable instructions or operations provided on a computer-readable medium. Thus, in one example, a computer-readable medium may store processor executable instructions operable to perform a method that includes one or more of the methods illustrated in FIGS. 3-7.

While FIGS. 3-7 illustrate various actions occurring in serial, it is to be appreciated that various actions illustrated in the figures could occur substantially in parallel. While a number of processes are described, it is to be appreciated that a greater and/or lesser number of processes could be employed and that lightweight processes, regular processes, threads, and other approaches could be employed. It is to be appreciated that other example methods may, in some cases, also include actions that occur substantially in parallel.

FIG. 3 illustrates an example method 300 for an audience response web server to communicate with audience response devices. At 310, the audience response web server may receive credentials data representing credentials from a device, user, or both seeking to join a polling session. At 320, based on the credentials data, the device may be granted or denied access to the polling session. At 330, method 300 may communicate polling data representing a polling question. At 340, method 300 may receive response data representing responses to the polling question. At 350, the web server may communicate results data representing aggregated responses to the polling question.

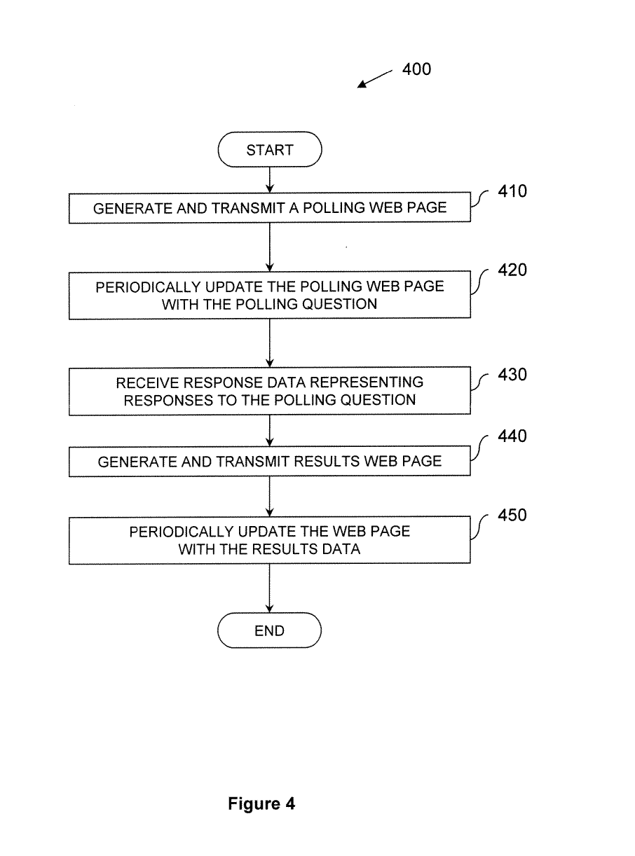

FIG. 4 illustrates an example method 400 for an audience response web server to communicate with web-enabled devices. At 410, the audience response web server may generate a polling web page. The web-enabled device may request, the web server may transmit or both the polling web page. At 420, the polling web page including question data or the polling data alone may be requested or transmitted periodically to keep the polling web page up-to-date. The web-enabled device may display or cause to be displayed the polling web page through a web browser. At 430, the web server may receive from the web-enabled device and other devices response data representing responses to the polling question. At 440, the audience response web server may generate a results web page incorporating results data representing aggregated responses to the polling question. Alternatively, the audience response web server may communicate the results data alone to keep the polling web page up-to-date. At 450, the web-enabled device may periodically request the results web page or the results data to update the polling web page. In one embodiment, the server may periodically communicate the data without requests from the web-enabled device. The web enabled device may display or cause to be displayed the aggregated results via the web browser.

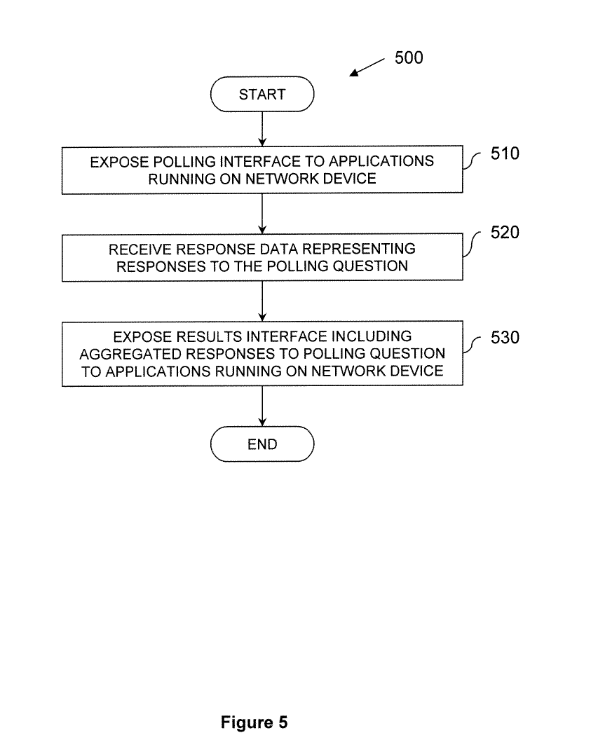

FIG. 5 illustrates an example method 500 for an audience response web server to communicate with a network device. At 510, the web server may expose a polling interface including the polling question to applications running on the network device. An application running on the network device may display or cause to be displayed the polling questions for a user to respond. The user may respond to the polling using any input devices or interfaces. At 520, the web server may receive response data representing responses to the polling question from devices, applications, or both, including an application running on the network device. At 530, the web server may expose a results interface to applications running on the network device, where the results interface includes aggregated responses to the polling question. The application running on the network device may then display or cause to be displayed the aggregated answers to the polling question.

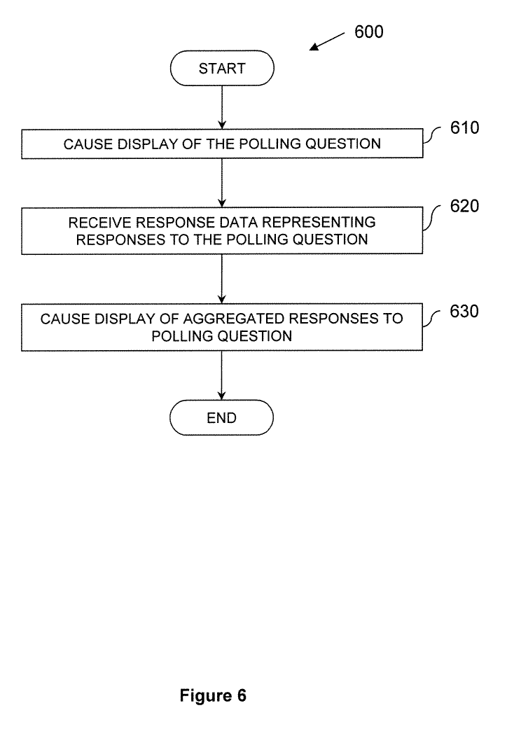

FIG. 6 illustrates a method for an audience response web server to communicate with a wireless device. At 610, the web server may cause display of the polling question. At 620, the web server may receive response data from devices including the wireless device. The response data includes data representing responses to the polling question. At 630, the web server may cause display of aggregated responses to the polling question.

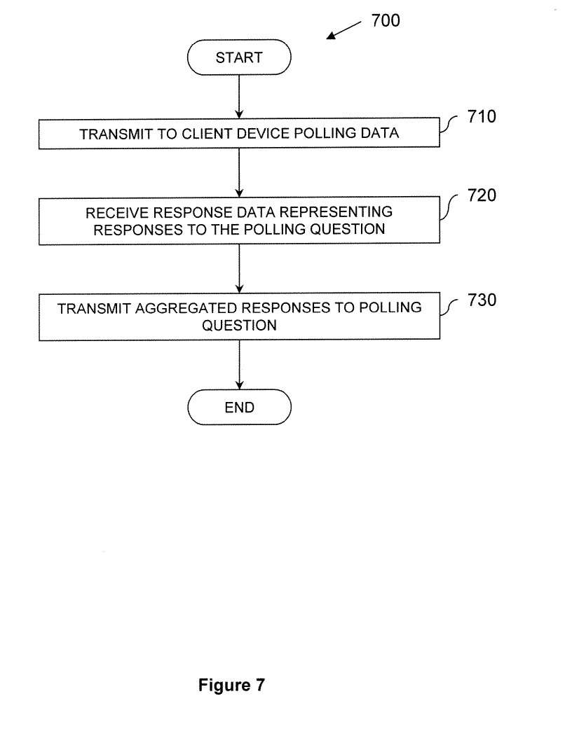

FIG. 7 illustrates a method for an audience response web server to communicate with a client device. A client device may be operably connected to the web server via TCP/IP or equivalent protocol. At 710, the web server may transmit to the client device polling data representing a polling question. At 720, the web server may receive response data from devices including the client device. At 730, the web server may transmit results data representing aggregated responses to the polling questions to the client device.

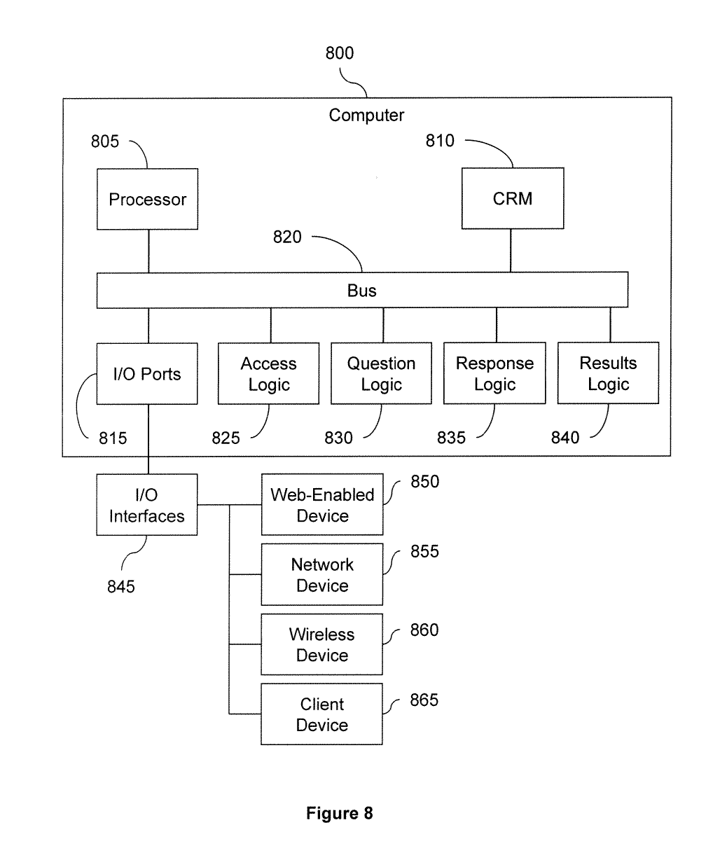

FIG. 8 illustrates a system including a computer 800 on which an example audience response web server may be implemented. Computer 800 may include a processor 805, a computer readable medium (“CRM”) 810, and I/O Ports 815 operably connected by a bus 820. In one example, computer 800 may include access logic 825 configured to control access to an interactive polling session. The computer 800 may further include question logic 830, response logic 835 and results logic 840 that, together, communicate data with devices joining the polling session. Access logic 825, question logic 830, response logic 835 and results logic 840 may be implemented in computer 800 as hardware, firmware, software, and/or a combination. For example, access logic 825, question logic 830, response logic 835 and results logic 840 may all be incorporated in processor 805. Additionally, access logic 825, question logic 830, response logic 835 and results logic 840 may provide means for implementing an audience response web server.

The processor 805 can be a variety of various processors including a dual microprocessor and other multi-processor architectures. The bus 820 can be a single internal bus interconnect architecture and/or other bus or mesh architectures. While a single bus is illustrated, it is to be appreciated that computer 800 may communicate with various devices, logics, and peripherals using other busses that are not illustrated (e.g., PCIE, SATA, Infiniband, 1394, USB, Ethernet). The bus 808 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial bus (USB), and a small computer systems interface (SCSI) bus.

The computer 800 may interact with input/output devices via I/O Ports 815 and I/O Interfaces 845. Input/output devices can include, but are not limited to, a web-enabled device 850, a network device 855, a wireless device 860, and a client device 865. The I/O Ports 815 can include, but are not limited to, Ethernet ports, serial ports, parallel ports, USB and micro USB ports, and wireless ports, such as infrared receivers and emitters and radio frequency receivers, transmitters, and transceivers.

The computer 800 can operate in a network environment and thus may be connected to web-enabled device 850, network device 855, wireless device 860, and client device 865 via the I/O Interfaces 845, and/or the I/O Ports 815. The computer 800 may interact with a network. Through the network, the computer 800 may be logically connected to remote computers. The networks with which the computer 800 may interact include, but are not limited to, a local area network (LAN), a wide area network (WAN), and other networks. Computer 800 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, Computer 800 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, and/or through a network may include combinations and mixtures of communications.

While example systems, methods, and so on, have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

What is claimed is:

1. An audience response web server comprising:
question logic configured to communicate a polling web page to at least one web enabled device, where the question logic is further configured to communicate question data representing a polling question to the at least one web enabled device during an interactive polling session running on the web server,
where the question logic is further configured to cause display of the polling question during the interactive polling session,
where the question logic is further configured to transmit to at least one client device the polling question during the interactive polling session, and
where the question logic is further configured to expose, during the interactive polling session, a polling interface incorporating the polling question to an application running on at least one network device;
response logic configured to receive response data representing responses to the polling question from the at least one web enabled device during the interactive polling session,
where the response logic is further configured to receive the response data from at least one wireless response device,
where the response logic is further configured to receive the response data from an audience response application running on the at least one client device, and
where the response logic is further configured to receive the response data from the application running on the at least one network device during the interactive polling session; and
results logic configured to communicate results data representing aggregated responses to the polling question to the at least one web enabled device during the interactive polling session running on the web server,
where the results logic is further configured to communicate to the at least one client device the results data representing the aggregated responses to the polling question during the interactive polling session,
where the results logic is further configured to cause display of the aggregated responses to the polling question during the interactive polling session, and
where the results logic is further configured to expose a results interface incorporating the aggregated responses to the polling question to the applications running on the at least one network device during the interactive polling session.

2. The web server of claim 1, further comprising access logic configured to control access by at least one of the at least one web enabled device, the at least one client device, the at least one wireless device and the at least one network device to the interactive polling session running on the web server.

3. An audience response web server comprising:
question logic configured to communicate polling data including a polling question during an interactive polling session running on the audience response web server;
response logic configured to receive response data representing responses to the polling question during the interactive polling session; and
results logic configured to communicate results data including aggregated responses to the polling question during the interactive polling session.

4. The audience response web server of claim 3, further comprising access logic configured to control access to the interactive polling session running on the audience response web server.

5. The audience response web server of claim 3, where the question logic is configured to communicate a polling web page to at least one web enabled device, where the question logic is further configured to communicate question data representing the polling question to the at least one web enabled device during the interactive polling session running on the audience response web server, where the response logic is configured to receive the response data from the at least one web enabled device during the interactive polling session running on the audience response web server, and where the results logic is configured to communicate results data representing the aggregated responses to the polling question to the at least one web enabled device during the interactive polling session running on the audience response web server.

6. The audience response web server of claim 5, where the question logic is further configured to cause display of the polling question during the interactive polling session running on the audience response web server, where the response logic is further configured to receive response data transmitted by at least one wireless response device, and where the results logic is further configured to cause display of the aggregated responses to the polling question during the interactive polling session running on the audience response web server.

7. The audience response web server of claim 5, where the question logic is further configured to transmit to at least one client device the polling data representing the polling question during the interactive polling session running on the audience response web server, where the response logic is further configured to receive the response data from an audience response application running on the at least one client device, and where the results logic is further configured to transmit the results data to the at least one client device during the interactive polling session running on the audience response web server.

8. The audience response web server of claim 5, where the question logic is further configured to expose a polling interface incorporating the polling question to at least one application running on the at least one network device during the interactive polling session, where the response logic is further configured to receive the response data from the at least one application during the interactive polling session, and where the results logic is further configured to expose a results interface incorporating the aggregated responses to the polling question to the at least one application during the interactive polling session.

9. The audience response web server of claim 3, where the question logic is further configured to expose a polling interface incorporating the polling question to at least one application running on the at least one network device during the interactive polling session, where the response logic is further configured to receive the response data from the at least one application during the interactive polling session, and where the results logic is further configured to expose a results interface incorporating the aggregated responses to the polling question to the at least one application during the interactive polling session.

10. The audience response web server of claim 9, where the question logic is further configured to cause display of the polling question during the interactive polling session running on the audience response web server, where the response logic is further configured to receive response data transmitted by at least one wireless response device, and where the results logic is further configured to cause display of the aggregated responses to the polling question during the interactive polling session running on the audience response web server.

11. The audience response web server of claim 9, where the question logic is further configured to transmit to at least one client device the polling data representing the polling question during the interactive polling session running on the audience response web server, where the response logic is further configured to receive the response data from an audience response application running on the at least one client device, and where the results logic is further configured to transmit to the at least one client device the results data during the interactive polling session running on the audience response web server.

12. A method for audience response polling implemented on an audience response web server, the method comprising:
communicating during a polling session polling data including a polling question;
receiving during the polling session response data representing responses to the polling question; and
communicating during the polling session results data representing aggregated responses to the polling question.

13. The method of claim 12, further comprising receiving credentials data representing credentials to join the polling session and granting access to the polling session upon determining that the credentials data meet pre-determined criteria.

14. The method of claim 12, where the communicating polling data includes communicating a polling web page and the polling data to a web enabled device for the web enabled device to display or cause to be displayed the polling web page including the polling data via a web browser, where the receiving response data representing responses to the polling question includes receiving the response data from the web enabled device, and where the communicating results data includes communicating the results data to the web enabled device for the web enabled device to display or cause to be displayed the polling web page including the results data via the web browser.

15. The method of claim 14, where the communicating polling data includes causing display of the polling question, where the receiving response data includes receiving the response data from at least one wireless device, and where the communicating results data includes causing display of the aggregated responses to the polling question.

16. The method of claim 14, where the communicating polling data includes communicating to at least one client device the polling data, where the receiving response data includes receiving the response data from the at least one client device, and where the communicating results data includes communicating the results data to the at least one client device.

17. The method of claim 14, where the communicating polling data includes exposing a polling interface including the polling question to at least one application running on at least one network device, where the receiving response data includes receiving the response data from the at least one network device, and where the communicating results data includes exposing to the at least one application running on the at least one network device. a results interface including the aggregated responses to the polling question

18. The method of claim 12, where the communicating polling includes exposing a polling interface including the polling question to an application running on a network device, where receiving response data includes receiving the response data from the application running on the network device, and where the communicating results data includes exposing a results interface including the aggregated responses to the polling question to the application running on the network device.

19. The method of claim 18, where the communicating polling data includes causing display of the polling question, where receiving response data includes receiving the response data from at least one wireless device, and where the communicating results data includes causing display of the aggregated responses to the polling question.

20. The method of claim 18, where the communicating during the polling session polling data representing a polling question includes communicating to at least one client device the polling data, where receiving during the polling session response data representing responses to the polling question includes receiving the response data from the at least one client device, and where the communicating during the polling session results data representing aggregated responses to the polling question includes communicating to the at least one client device the results data.
